(19) United States
(12) Patent Application Publication
(10) Pub. No.: US 2008/0277481 A1
(43) Pub. Date: Nov. 13, 2008

(54) Renewable cards

(76) Inventors: David Engel, Toronto (CA); William J. Garland, Mississauga (CA)

Correspondence Address: CARR & FERRELL LLP, 2200 GENG ROAD, PALO ALTO, CA, 94303, US

(21) Appl. No.: 12/074,552

(22) Filed: Mar. 3, 2008

Related U.S. Application Data
(60) Provisional application No. 60/928,820, filed on May 11, 2007.

(51) Int. Cl. G06K 19/02

(52) U.S. Cl. 235/488

(57) ABSTRACT

Various aspects are directed toward the fabrication of cards, cardstock and card products made from renewable and/or inert materials. Information cards fabricated from such materials are disclosed. Information cards generally include annotation regions, and often include protective layers fabricated from renewable polymers or inert polymers. Methods directed toward the fabrication of renewable cards, card products and cardstock are disclosed.

### CROSS REFERENCE TO RELATED APPLICATIONS

This U.S. nonprovisional patent application claims the priority benefit of U.S. provisional patent application No. 60/928,820 filed on May 11, 2007 and entitled “Environmentally Friendly Card Project,” which is incorporated herein by reference.

### BACKGROUND

1. Technical Field

The present invention relates generally to the fabrication of cards, and more particularly, to the fabrication of cards from environmentally friendly materials, including renewable and/or inert materials.

2. Description of Related Art

A wide variety of cards, cardstock, and card products are manufactured using petrochemically-derived materials. Examples of such cards include credit cards, debit cards, loyalty cards, gift cards, telephone cards, prepaid purchase cards, cellular communications cards, membership cards, student cards, identification cards and transit cards. These cards may contain petrochemically-derived materials such as polyvinyl chloride (PVC), polystyrene, polyester, polypropylene, polyolefins, polyethylene, polycarbonate, and pthalates. Although some cards include a paper core, common manufacturing requires a protective polymer coating, which is generally a petrochemically-derived polymer.

The synthesis of petrochemically-derived polymers often entails substantial harm to the environment as toxic hemicals are typically released. Further, after the cards are disposed of, the petrochemically-derived polymers in the cards degrade very slowly.

The replacement of the petrochemically-derived polymers with more environmentally friendly materials such as plastics made of renewable polymers or inert polymers may decrease the environmental impact of cards, cardstock, and card products.

### SUMMARY OF THE INVENTION

Various embodiments provide an information card comprising a substantially planar base layer fabricated from a first renewable polymer or inert polymer and an annotation region on at least a portion of a first surface of the base layer. The annotation region is configured to retain information for electronically accessing data associated with the information card. A protective layer may be affixed to either surface of the base layer, and in some aspects, the protective layer protects the annotation region from degradation. The protective layer may be transparent, and in some cases is affixed using a renewable adhesive. In some aspects, a base layer and/or a protective layer is fabricated from polylactide.

Embodiments include methods for fabricating an information card, including providing a substantially planar base layer formed of a first renewable material and forming a first annotation region on at least a portion of a first surface of the base layer. Generally, the annotation region configured to retain information for electronically accessing data associated with the information card. Embodiments include applying a first protective layer comprising a second renewable polymer to the first surface of the base layer in a manner that protects the annotation region from degradation. Embodiments may also include applying a protective layer to a surface of the base layer that does not include an annotation region.

Certain embodiments include an information card comprising a substantially planar base layer fabricated from an opaque polylactide, and further include an annotation region configured to retain information for electronically accessing data associated with the information card. The annotation region may be printed on a first surface of the base layer, and the annotation region may include an ink made from vegetable-based oil. Aspects include a substantially planar protective layer fabricated from transparent polylactide, and various aspects include a pressure sensitive adhesive that sealingly affixes the protective layer to the first surface of the base layer in a manner that protects the annotation region from degradation.

Other embodiments include an information card comprising a substantially planar base layer fabricated from a first renewable material, an annotation region on at least a portion of a first surface of the base layer, and a substantially planar first protective layer fabricated from a first renewable polymer. The annotation region may be configured to retain information for electronically accessing data associated with the information card. The first protective layer may be sealingly affixed to the first surface of the base layer in a manner that protects the annotation region from degradation. Embodiments also may include a second substantially planar protective layer fabricated from a second renewable polymer. This second protective layer may be sealingly affixed to a second surface of the base layer, opposite the first surface of the base layer.

### BRIEF DESCRIPTION OF THE DRAWINGS

FIG. 1A is a schematic of a base layer according to various embodiments.

FIG. 1B is a schematic of a base layer with an annotation region according to various embodiments.

FIG. 1C is a schematic of a base layer, annotation region, and protective layer according to various embodiments.

FIG. 2A is a schematic of a first embodiment of an information card.

FIG. 2B is a schematic of a second embodiment of an information card.

FIG. 2C is a schematic of a third embodiment of an information card.

FIG. 2D is a schematic of a fourth embodiment of an information card.

FIG. 2E is a schematic of a fifth embodiment of an information card.

FIG. 3 is a schematic of an exemplary architecture for an information card.

FIG. 4A is a flowchart describing a first method for fabricating an information card according to an embodiment.

FIG. 4B is a flowchart describing a second method for fabricating an information card according to an embodiment.

### DETAILED DESCRIPTION OF THE INVENTION

Aspects of the invention involve the fabrication of cards, renewable cards, renewable card products and renewable cardstocks. For the purposes of this specification, a card product refers to any product fabricated from cardstock. Cardstock refers to a substantially planar material that is much thinner (e.g. by a factor of 10, 100, 1000, or greater) than it is long and wide, such that it can be used for the fabrication of cards, boxes, packaging, envelopes, or similar objects. Typical thicknesses of cardstock range from 1 to 100 points (or mils) thick.

In general, a primary difference between cardstock and a card is lateral dimension. Cards are generally characterized by lengths and widths having similar magnitudes (e.g., 3 inches by 5 inches for a “3×5 card”), and these magnitudes are typically of the order of a few inches in each dimension. Cardstock is typically long and wide enough that automated machinery can efficiently manufacture large quantities of cards or card products from a single piece of cardstock. Cardstock widths may be several inches, a few feet, or even tens of feet, and lengths may be several inches, a few feet, tens of feet, or even hundreds of feet. During manufacture of card products, cardstock is often cut or die cut into cards, which are typically small enough in size to allow for convenient handling by the user. Thus a business card may have lateral dimensions of approximately 2 inches×3.5 inches, but be fabricated from cardstock that is several feet in width and (in some cases) hundreds of feet in length. Cardstock may often be processed in a manner that creates many card products (other than cards) from a single piece of cardstock that is subsequently cut to form discrete card products.

A renewable polymer is a polymer manufactured from materials that are readily replaceable by new growth. These materials include vegetable-based feedstocks such as corn, sugar cane, or other crops. In some embodiments, renewable polymers may include polymers derived from waste products. Examples of renewable polymers include polylactide (PLA), polyhydroxyalkanoate (PHA), and polyhydroxybutyrate (PHB). An inert polymer is a polymer derived from materials that are not significantly reactive with other materials. Examples of inert polymers may include polyester polymers, high impact polystyrene, Pro-Print®), Synthetic Paper, Transalloy® P-300 Multi-Polymer Alloy, Transalloy® P-260EX Multi-Polymer Alloy, etc. Inert polymers, as referred to in this application, may include polymers that biodegrade (e.g. into inert materials). Some polymers may be both renewable and inert.

In some embodiments, a polymer may require a short period of time to degrade naturally (e.g., PLA is degradable within sixty days under ideal conditions). Natural degradation may include decomposition caused by a photodegradable process, microorganisms, through exposure to water, or a combination of these. This may be due to the polymer being derived from at least one of the vegetable-based feed stocks.

For the purposes of this specification, an information card is a substantially planar card product, having dimensions of a few inches or less in length and width, that includes an annotation region configured to retain information for electronically accessing data associated with the information card. An information card incorporates information that can be conveyed to a user of the card. An information card can also incorporate information from a user (e.g., a user's signature). In general, an information card may be fabricated from cardstock, and a material that can be fabricated into an information card may be considered cardstock. These latter applications are categorized as “card products.”

Cards such as credit cards, debit cards, loyalty cards, gift cards, telephone cards, cellular communications cards, prepaid purchase cards, membership cards, student cards, identification cards, and transit cards are exemplary types of information cards. Information cards may also include marketing and/or advertising information.

For convenience, various aspects are described in the context of a single information card, although these aspects are equally applicable to cardstock and card products that convey information.

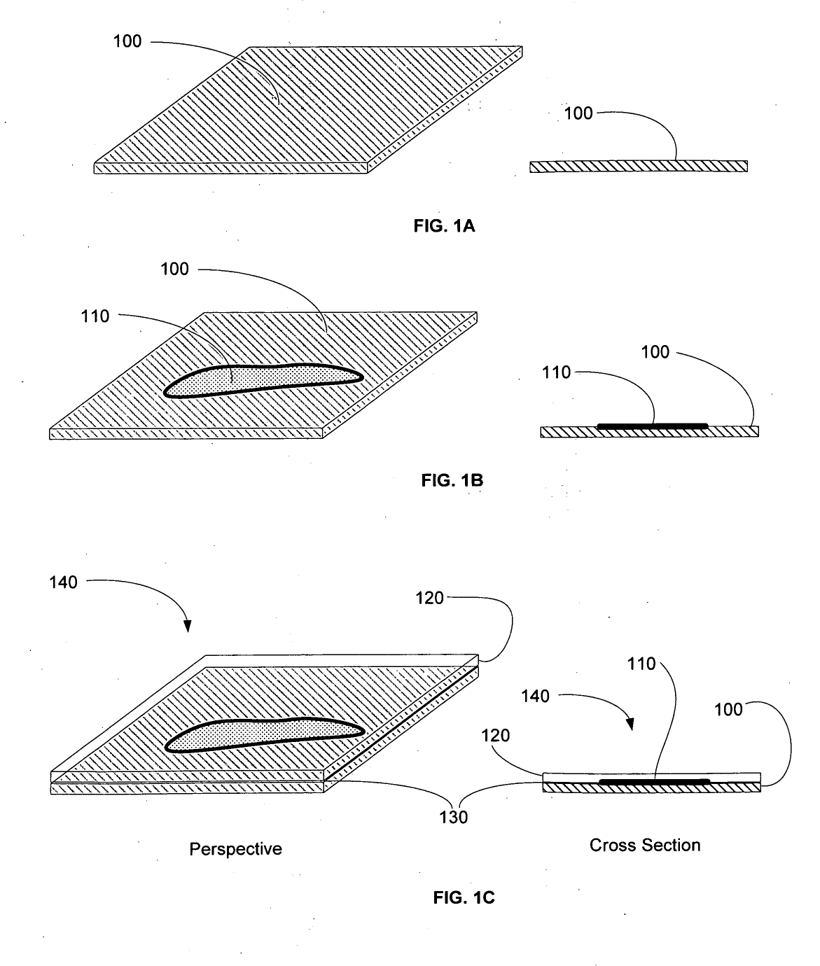

FIG. 1A is a schematic of a base layer 100 according to various embodiments. Base layer 100 is a renewable material or inert material having a thickness substantially smaller than its length and width. In general, the thickness of the base layer 100 will be determined by the application toward which a card is directed, but typical thicknesses may be from 10 to 100 points (or mils or thousandths of an inch) thick. Base layer 100 may be based on PLA, PHA, PHB, or any number of other renewable materials. Alternatively, base layer 100 may be based on an inert material. In some embodiments, the base layer 100 may be made of paper.

FIG. 1B is a schematic of a base layer 100 with an annotation region 110 according to various embodiments. The annotation region 110 is configured to retain information for electronically accessing data associated with the information card. For the purposes of this specification, the general process of adding information to a base layer 100 is referred to as annotation, and doing so creates the annotation region 110. Whether annotated information is attached as a separate entity, printed, embossed, or otherwise added to base layer 100, the annotation region 110 contains the annotated information.

An annotation region 110 can be embossed, etched, scored, cut, dyed, bleached, or otherwise engraved on the base layer 100. An annotation region 110 may also be printed, screened, painted, sublimated, written, or otherwise deposited on the base layer 100 in a manner that adds material to the base layer 100. For information annotated on the base layer 100 via deposition or printing, the use of inks or paints based on renewable materials, particularly inks based on vegetable oils, may be desirable. Information may be printed on the base layer 100 using thermal printing, dye sublimation printing, ink jet printing, laser printing, and magnetography printing, flexographic printing, and offset printing. Those skilled in the art will appreciate that there are many ways to annotate the base layer 100.

An annotation region 110 may also include a discrete, information-carrying component, such as a magnetic strip carrying a magnetizable material, whose magnetization pattern carries information. An annotation region 110 may also include random access memory (RAM), read only memory (ROM), flash memory, programmable-ROM, ferroic memory, or any other computer readable media that can carry information. In some embodiments, the annotated region 110 includes an electronically readable “smart card.” An annotation region 110 may include a radio-frequency identification (RFID) chipset or an “electronic ink” material, as will be apparent to those skilled in the art.

The annotation region 110 can also include an image, a pattern, a shape, a logo, a barcode, a two-dimensional barcode and/or text. The annotation region 110 may include a surface finish, a roughness, a tactile “feel,” a specific elastic response, a reflectivity or any other physical parameter that may be incorporated in a fashion such that its value is associated with a particular person or entity.

In various embodiments, information may be annotated onto the annotation region 110 in a fashion that enhances the efficient fabrication of products from cardstock. For example, a large number of annotation regions 110 (e.g., logos or text blocks) may be printed on cardstock in a regular pattern, such that the cardstock can subsequently be cut into discrete units, each having a base layer 100 that has identical information printed thereon. As is known to those skilled in the art, a similar pattern can also be used to annotate distinct information onto each annotation region 110 (such as a unique barcode or smart chip) such that the subsequent cutting of the cardstock results in base layers 100 having different annotation regions 110.

Additional features can also be included as part of an information card. For example, a lenticular lens or fresnel lens may be incorporated into annotation region 110 during fabrication, and in some cases the lens may be fabricated from the material used for base layer 100. The annotation region 110 may also include a reflective (e.g., metal foil) layer or holographic layer, a security feature, or an anti-tampering device.

FIG. 1C is a schematic of a base layer, annotation region, and protective layer according to various embodiments. Information card 140 includes base layer 100, annotation region 110 and protective layer 120. Because degradation can corrupt the information conveyed by the annotation region 110 (e.g., rendering printed text unreadable), an information card 140 may include the protective layer 120 to prevent degradation. Protective layer 120 is attached to base layer 100, and in exemplary information card 140, these layers are adhered to each other using adhesive 130.

Protective layer 120 may be a renewable material or an inert material that is sealingly affixed to base layer 100 and annotation region 110. Protective layer 120 prevents degradation of the information conveyed by the annotation region 110 for a limited duration. For optically recognizable information (such as printing), the protective layer 120 may be transparent, an example of which is transparent PLA. For information that can be transmitted through opaque materials (e.g., if annotation region 110 includes a magnetic strip), the protective layer 120 may be opaque. For a component of annotation region 110 that requires physical contact to the outside world (e.g., electronic pins in a smart card) the protective layer 120 may have appropriate gaps or access points. Protective layer 120 may be of similar dimensions to base layer 100.

The protective layer 120 may be affixed to base layer 100 using a method that does not require an additional adhesive material (e.g., by diffusion bonding or thermal welding). Optionally, protective layer 120 may be affixed to base layer 100 using an adhesive, which is shown in FIG. 1C as adhesive 130, at the interface between base layer 100 and protective layer 120. The thickness and opacity of adhesive 130 are such that any transparency requirements of the combination of protective layer 120 and adhesive 130 are fulfilled. In some aspects, a solvent-free adhesive may be used, and in several aspects, an adhesive with minimal (or even no) solids loading may be used.

An example arrangement of the base layer 100, annotation region 110, and protective layer 120 is shown in FIG. 1C as information card 140. However, many other arrangements are within the scope of the invention.

In general, many information cards will be fabricated according to industry-standard specifications that are particular to the type of information card being fabricated. Exemplary standards include the CR80 “credit card” format (approximately 3.375″ by 2.125″ by 0.2 points to 0.3 points thickness and the CR50 “luggage tag” format (approximately 3.5″ by 2.09375″ by 0.20 points thickness. A compact disc case may include an information card approximately 4 inches square, and a direct mailing insert may include an information card of dimensions 8.5 by 11 inches. However, the present invention is not limited to a particular (or even any) industry standard dimension, nor is it limited to a particular method of information annotation.

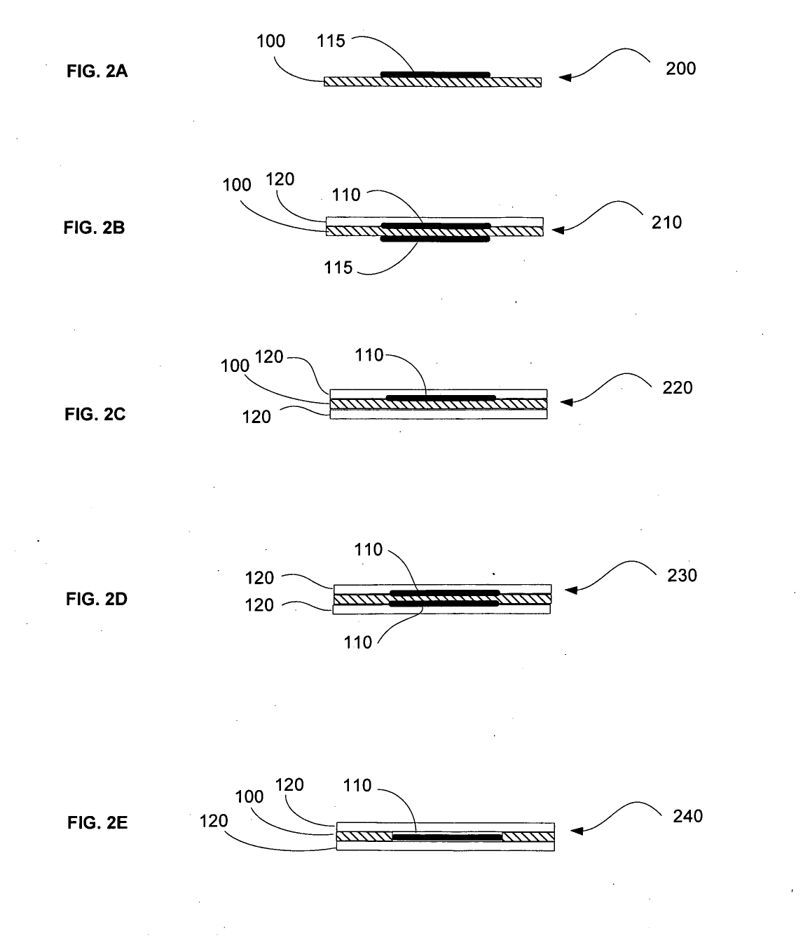

FIGS. 2A-2E are schematics showing examples of different arrangements of components in an information card. In each of these examples, adhesive may or may not be used and is omitted for clarity. These examples are for illustrative purposes only and are not intended to be limiting.

FIG. 2A is a schematic of a first embodiment of an information card 200. Information card 200 includes an annotation region 115 that does not require additional protection, such as an embossed logo, an etched bar code, or a smart card affixed to the base layer.

FIG. 2B is a schematic of a second embodiment of an information card 210. Information card 210 includes both an annotation region 110 beneath protective layer 120 and another annotation region 115 on the opposite side of base layer 100. Information card 210 could be a card having protected text on one side and an unprotected magnetic strip on the other side. For an information card 210 in which a user writes on an annotation region, it may be advantageous to include a writable surface as part of annotation region 115. Exemplary writing surfaces include a hot foil writable patch, a printed writeable coating, or even a label.

FIG. 2C is a schematic of a third embodiment of an information card 220. Information card 220 includes annotation region 110 and base layer 100 between two protective layers 120. Information card 220 may provide protection of base layer 100 by the protective layers 120, even on a side where base layer 100 does not carry information. The mechanical properties of information card 220 may be enhanced by choosing protective layers 120 made of a different material than that of base layer 100. Typical thicknesses of an exemplary information card 220 having printed annotation region 110 include seven-point protective layers 120 on both sides of a twelve-point base layer 100, or ten-point protective layers 120 on both sides of a ten-point base layer 100.

The configuration of information card 220 may also be used to annotate a particularly thin base layer 100 (e.g., less than 10 mils thick) via an annotation method that requires the thin base layer (e.g., newsprint methods). The card can then be thickened, stiffened or made stronger by incorporating protective layers 120 (e.g., having thicknesses of ten mils or more) as shown.

FIG. 2D is a schematic of a fourth embodiment of an information card 230. Information card 230 shows an embodiment in which information is conveyed on both sides of the card via two annotation regions 110. The information card 230 additionally includes two protective layers 120 sealingly affixed to the two annotation regions 110.

FIG. 2E is a schematic of various embodiments of an information card 240. Information card 240 includes an area in base layer 100 such that annotation region 110 provides for a transparent region in the information card 240. Annotation region 110 may also comprise a lens in this configuration.

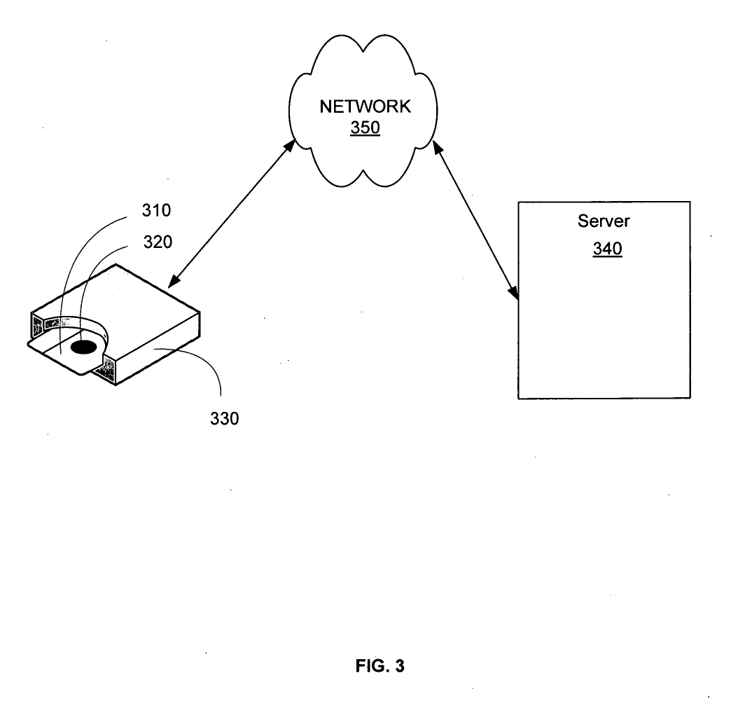

FIG. 3 is a schematic of an exemplary architecture for an information card. Information card 310 includes annotation region 320, which may be a printed bar code, an identification number, a magnetic strip, a smart chip, or any other type of information that provides for the interaction of information card 310 with an appropriate card reader 330. Card reader 330 is an apparatus appropriately matched to the type of information card 310 and annotation region 320. For example, card reader 330 may be a bar code reader or other optical device if annotation region 320 includes a bar code. Alternatively, card reader 330 may be a magnetic strip reader or a device to access information from a smart card. Card reader 330 typically includes sufficient processing, memory, sensing, and communications hardware necessary to access information from information card 310, convert the information to digital form and transmit the information electronically. Transmission may include the use of the Internet Protocol. Card reader 330 may also include a display device to display information to the user, and may also include appropriate hardware to process a financial transaction based on information in annotation region 320. Although card reader 330 is schematically shown as a compact device substantially enclosing information card 310, card reader 330 may have a different geometric configuration, such as a hand held optical scanner. If annotation region 320 includes an RFID chip, card reader 330 may be an appropriate reading apparatus disposed at a substantial distance (e.g., 1 foot, 3 feet or even 10 feet) from information card 310.

Card reader 330 reads information from and may also write information to annotation region 320. In other aspects, card reader 330 may transmit the information to server 340 over network 350. Network 350 may include a local area network (LAN), wide area network (WAN), or the like. Server 340 includes a processor, memory, storage device, network hardware, input/output hardware, along with appropriate software. Server 340 also includes a computer readable storage medium, having embodied thereon a program, the program operable by a processor to perform a method comprising electronically accessing data associated with the information card 310. Server 340 may include account information related to information card 310, as is typical for information cards such as credit cards, loyalty cards, transit cards, and the like.

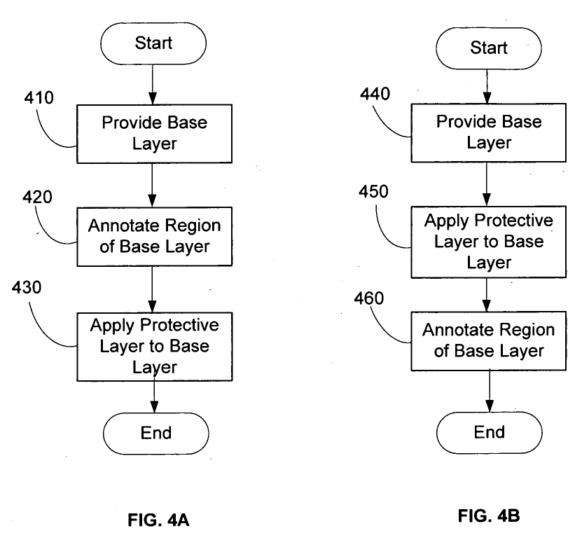

FIG. 4A is a flowchart describing a first method for fabricating an information card according to an embodiment. An exemplary information card, such as information card 140, that includes an annotation region 110 requiring protection from degradation may be fabricated according to the method in FIG. 4A. In step 410, a base layer, such as base layer 100, made of a renewable material or an inert material. A renewable polymer like polylactide is provided.

In step 420, an annotation region is annotated on the base layer.

In step 430 a protective layer, such as protective layer 120, is laminated to the annotated base layer. The protective layer laminated to the base layer may be a renewable polymer such as transparent polylactide. Alternative embodiments may include a protective layer made of an inert polymer.

Some annotation regions may not require protective layers, and a protective layer may be applied to a surface of a base layer not having an annotation region. An affixed protective layer may provide structural strength, a preferred elastic response, shape constraint, flatness constraint or other properties of the protective layer. Thus, step 430 may be repeated for the opposite surface of the base layer, such that the base layer is sandwiched between two protective layers.

FIG. 4B is a flowchart describing a second method for fabricating an information card according to an embodiment. The method described in FIG. 4B provides an example of a protective layer providing additional features other than protection of the annotation region. In step 440, a base layer made from a renewable material or inert material is provided. For example, this base layer may be a renewable polymer or even a renewable fibrous material such as paper. In step 450, a protective layer made from a renewable polymer or inert polymer is laminated to the base layer. In some embodiments, a protective layer may be laminated to both sides of the base layer. In step 460, an annotation region is formed on the laminated base layer. In some embodiments, this annotation region may include a magnetic strip or smart chip or other annotation region not requiring protection that is affixed to the protective layer.

Lamination in steps 430 or 450 may be performed using a pressure sensitive adhesive. Lamination may also be performed using a thermal adhesive. Thermal adhesives are often characterized by a bonding temperature, which may be a temperature above which the adhesive must be heated before its bonding properties are activated. In various aspects, a thermal adhesive with a bonding temperature below 170 degrees Fahrenheit is used, and a thermal adhesive with a bonding temperature below 150 degrees Fahrenheit or even below 140 degrees Fahrenheit may be used. The lamination in steps 430 or 450 will generally be chosen according to the thermal, elastic and other physical properties of the materials being laminated, including the properties of the base layer, protective layer, and optionally the annotation region.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. An information card comprising:
a substantially planar base layer fabricated from a first renewable polymer; and
an annotation region on at least a portion of a first surface of the base layer, the annotation region configured to retain information for electronically accessing data associated with the information card.

2. The information card of claim 1, further comprising a substantially planar first protective layer fabricated from a second renewable polymer, the first protective layer sealingly affixed to the first surface of the base layer in a manner that protects the annotation region from degradation.

3. The information card of claim 2, wherein the first protective layer is at least partially transparent.

4. The information card of claim 2, wherein the first protective layer is sealingly affixed using a renewable adhesive.

5. The information card of claim 4, wherein the renewable adhesive is a pressure-sensitive adhesive.

6. The information card of claim 4, wherein the renewable adhesive is a thermal adhesive.

7. The information card of claim 6, wherein the renewable adhesive is characterized by a bonding temperature below 170 degrees Fahrenheit.

8. The information card of claim 1, wherein the annotation region is configured to retain information selected from the group consisting of credit card information, debit card information, loyalty card information, gift card information, telephone information, cellular communications information, prepaid purchase information, membership information, student information, identification information, transit information, holiday information, and direct marketing information.

9. The information card of claim 1, wherein the annotation region includes any of an embossed region, etched region, scored region, cut region, dyed region, bleached region, and engraved region in the base layer.

10. The information card of claim 1, wherein the annotation region includes any of a printed region, screened region, painted region, and sublimated region.

11. The information card of claim 1, wherein the annotation region includes any of a magnetic strip, smart chip, holographic image layer, and RFID chipset.

12. The information card of claim 1, wherein the annotation region comprises a transparent region of the base layer.

13. The information card of claim 1, wherein the first renewable polymer is polylactide.

14. The information card of claim 2, wherein any of the first and second renewable polymers is polylactide.

15. The information card of claim 1, wherein the annotation region includes an ink based on vegetable oil.

16. A method of fabricating an information card comprising:
providing a substantially planar base layer formed of a first renewable polymer;
forming a first annotation region on at least a portion of a first surface of the base layer, the annotation region configured to retain information for electronically accessing data associated with the information card; and
applying a first protective layer comprising a second renewable polymer to the first surface of the base layer in a manner that protects the annotation region from degradation.

17. The method of claim 16, further comprising applying a second protective layer comprising a third renewable polymer to a second surface of the base layer, the second surface of the base layer opposite the first surface of the base layer.

18. The method of claim 16, further comprising forming a second annotation region on at least a portion of a surface of the first protective layer.

19. The method of claim 16, further comprising forming a second annotation region on at least a portion of a surface of the first protective layer, and the second annotation region includes any of a magnetic strip, an RFID chip, and a smart card.

20. The method of claim 17, further comprising forming a second annotation region on at least a portion of a surface of any of the first and second protective layers.

21. The method of claim 17, further comprising forming a second annotation region on at least a portion of a surface of any of the first and second protective layers, and the second annotation region includes any of a magnetic strip, an RFID chip, and a smart card.

22. The method of either of claims 16 and 17, wherein applying any of the first and second protective layers comprises using a pressure sensitive adhesive.

23. The method of either of claims 16 and 17, wherein applying any of the first and second protective layers comprises using a thermal adhesive.

24. An information card comprising:
a substantially planar base layer fabricated from an opaque polylactide;
an annotation region configured to retain information for electronically accessing data associated with the information card, the annotation region printed on a first surface of the base layer and comprising an ink made from vegetable-based oil;
a substantially planar protective layer fabricated from transparent polylactide; and
a pressure-sensitive adhesive that sealingly affixes the protective layer to the first surface of the base layer in a manner that protects the annotation region from degradation.

25. An information card comprising:
a substantially planar base layer fabricated from a first renewable material;
an annotation region on at least a portion of a first surface of the base layer, the annotation region configured to retain information for electronically accessing data associated with the information card;
a substantially planar first protective layer fabricated from a first renewable polymer, the first protective layer sealingly affixed to the first surface of the base layer in a manner that protects the annotation region from degradation; and
a substantially planar second protective layer fabricated from a second renewable polymer, the second protective layer sealingly affixed to a second surface of the base layer, the second surface of the base layer opposite the first surface of the base layer.

26. An information card comprising:
a substantially planar base layer fabricated from a first inert polymer; and
an annotation region on at least a portion of a first surface of the base layer, the annotation region configured to retain information for electronically accessing data associated with the information card.

27. A method of fabrication an information card comprising:
providing a substantially planar base layer formed of a first inert polymer;
forming a first annotation region on at least a portion of a first surface of the base layer, the annotation region configured to retain information for electronically accessing data associated with the information card; and
applying a first protective layer comprising a second renewable polymer to the first surface of the base layer in a manner that protects the annotation region from degradation.

28. An information card comprising:
a substantially planar base layer fabricated from a first inert material;
an annotation region on at least a portion of a first surface of the base layer, the annotation region configured to retain information for electronically accessing data associated with the information card;
a substantially planar first protective layer fabricated from a first renewable polymer, the first protective layer sealingly affixed to the first surface of the base layer in a manner that protects the annotation region from degradation; and
a substantially planar second protective layer fabricated from a second renewable polymer, the second protective layer sealingly affixed to a second surface of the base layer, the second surface of the base layer opposite the first surface of the base layer.
